(19) United States
(12) Patent Application Publication
(10) Pub. No.: US 2026/0338208 A1
(43) Pub. Date: Oct. 29, 2026

(54) Systems and Methods for a Modular Hydraulic Control Valve

(71) Applicant: HUSCO International, Inc., Waukesha, WI (US)

(72) Inventor: Ravindra Arun GONTE, Northwich (GB)

(21) Appl. No.: 19/104,832

(22) PCT Filed: Aug. 21, 2023
(86) PCT No.: PCT/US2023/030722

§ 371 Date: Feb. 19, 2025

Related U.S. Application Data
(60) Provisional application No. 63/371,960, filed on Aug. 19, 2022.

(51) Int. Cl. F15B 13/08; F15B 13/00

(52) U.S. Cl. CPC F15B 13/0817; F15B 13/0839; F15B 13/0878; F15B 2013/006

(57) ABSTRACT

A modular hydraulic valve can be used to operatively couple one or more pumps to one or more consumers without the need for spacing elements between adjacent valve sections. The modular valve can include a valve stack secured between two covers that define pump inlets. The valve stack can include a plurality of valve sections arranged into valve section assemblies, each configured to receive flow from one or more of the pump inlets. Each valve section can be formed by selecting either a first housing configuration or a second housing configuration and inserting one of three different types of spools into the housing, thereby coupling the valve section to the desired one or more pump inlets.

### CROSS REFERENCE TO RELATED APPLICATIONS

The present application is based on and claims the benefit of U.S. Provisional Patent Application No. 63/371,960, filed on Aug. 19, 2022, which is incorporated herein by reference in its entirety.

### BACKGROUND

The present disclosure relates generally to hydraulic valve assemblies for hydraulic systems.

### SUMMARY

According to one aspect of the present disclosure, a hydraulic valve is provided. The hydraulic valve can include a first cover defining a first pump inlet configured to couple to a first pump and a second pump inlet configured to couple to a second pump. The hydraulic valve can further include a first valve section assembly and a second valve section assembly. The first valve section assembly can include a first valve section. The first valve section can include a first housing in a first housing configuration that can define a first pump passage, a second pump passage, a first work port, and a first tank port. The first pump passage can be configured to couple to the first pump inlet and can extend entirely through the first housing. The second pump passage can be configured to couple to the second pump inlet and can extend partially through the first housing. The first valve section can further include a first spool that can move within the first housing to selectively couple the first work port to the first tank port and at least one of the first pump passage and the second pump passage. The second valve section assembly can be disposed between the first cover and the first valve section assembly and can include a second valve section. The second valve section can include a second housing in a second housing configuration that can define a third pump passage, a fourth pump passage, a second work port, and a second tank port. The third pump passage can be configured to couple to the first pump inlet and can extend entirely through the second housing. The fourth pump passage can be configured to couple to the second pump inlet and can extend entirely through the second housing The second valve section can further include a second spool that can move within the second housing to selectively couple the second work port to the second tank port and at least one of the third pump passage and the fourth pump passage. The first valve section can be directly coupled to the second valve section so that the first pump passage can be in fluid communication with the third pump passage and the second pump passage can be blocked from the fourth pump passage.

In some non-limiting examples, the first valve section assembly can include a third valve section coupled to the first valve section opposite the second valve section assembly. The third valve section can include a third housing in the first housing configuration.

In some non-limiting examples, the second valve section assembly can include a fourth valve section coupled between the second valve section and the first cover. The fourth valve section can include a fourth housing in the second housing configuration.

In some embodiments, the hydraulic valve can further include a second cover. The first valve section assembly can be coupled between the second cover and the second valve section assembly. The second cover can define at least one of a third pump inlet configured to couple to a third pump and a fourth pump inlet configured to couple to a fourth pump. In some cases, the first pump and the fourth pump can be the same pump.

In some non-limiting examples, a third valve section assembly can be disposed between the second cover and the first valve section assembly. The third valve section assembly can include a fifth valve section with a fifth housing in the first housing configuration. The first pump passage of the fifth valve section can be configured to couple to the fourth pump inlet and the second pump passage of the fifth valve section can be configured to couple to the third pump inlet. Further, the first pump passage of the fifth valve section can be in fluid communication with the first pump passage of the first valve section, and the second pump passage of the fifth valve section can be blocked from the second pump passage of the first valve section. In some cases, the third valve section assembly can further include a sixth valve section with a sixth housing in the second housing configuration. The third pump passage of the sixth valve section can be in fluid communication with the first pump passage of the fifth valve section and the fourth pump passage of the sixth valve section can be in fluid communication with the second pump passage of the fifth valve section.

In some non-limiting examples, the first spool can be in one of a first spool configuration that allows fluid to flow between the first pump passage and the second pump passage, a second spool configuration that blocks fluid flow between the first pump passage and the second pump passage, and a third spool configuration that can include a check valve to allow unidirectional flow between the first pump passage to and the second pump passage.

According to another aspect of the present disclosure, a hydraulic valve is provided. The hydraulic valve can include a first cover defining a first pump inlet and a second pump inlet, a second cover defining a third pump inlet and a fourth pump inlet, and a first valve stack arranged between the first cover and the second cover. The first valve stack can include a first valve section assembly, a second valve section assembly, and a third valve section assembly. The first valve section assembly can include a first housing in a first housing configuration that can define a first pump passage configured to couple to the first pump inlet and a second pump passage configured to couple to the second pump inlet. The first pump passage can extend entirely through the first housing and the second pump passage can extend partially through the first housing. The second valve section assembly can be disposed between the first cover and the first valve section assembly. The second valve section assembly can include a second housing in a second housing configuration that can define a third pump passage configured to couple to the first pump inlet and a fourth pump passage configured to couple to the second pump inlet. The third pump passage and the fourth pump passage can extend entirely through the second housing. The third valve section assembly can be disposed between the second cover and the first valve section assembly. The third valve section assembly can include a third housing in the first housing configuration. The first pump passage of the third housing can be configured to couple to the third pump inlet and the second pump passage of the third housing can be configured to couple the fourth pump inlet.

In some non-limiting examples, the first cover can further define a fifth pump inlet and a sixth pump inlet. The hydraulic valve can further include a third cover defining seventh pump inlet and an eighth pump inlet, and a second valve stack arranged between the first cover and the third cover. The second valve stack can include a fourth valve section assembly, a fifth valve section assembly, and a sixth valve section assembly. The fourth valve section assembly can include a fourth housing in the first housing configuration. The first pump passage of the fourth housing can be configured to couple to the fifth pump inlet and the second pump passage of the fourth housing can be configured to couple the sixth pump inlet. The fifth valve section assembly can be disposed between the first cover and the fourth valve section assembly, and can include a fifth housing in the first housing configuration. The first pump passage of the fifth housing can be configured to couple to the fifth pump inlet and the second pump passage of the fifth housing can be configured to couple the sixth pump inlet. The sixth valve section assembly can be disposed between the third cover and the fourth valve section assembly and can include a sixth housing in the second housing configuration. The third pump passage of the sixth housing can be configured to couple to the seventh pump inlet and the fourth pump passage of the sixth housing can be configured to couple to the eighth pump inlet.

In some cases, for each of the first housing configuration and the second housing configuration, the respective housing (i.e., a housing in the first housing configuration or the second housing configuration) can define a bore configured to moveably receive a spool, which can selectively couple a work port to a tank port and a pump passage. For each of the first valve section assembly and the fourth valve section assembly, each spool can be in a first configuration that allows flow between the pump passages within the respective housing. For each of the second valve section assembly, the third valve section assembly, the fifth valve section assembly, and the sixth valve section assembly, each spool can be in a second configuration that blocks flow between the pump passages of the respective housing.

According to yet another aspect of the present disclosure, a hydraulic valve assembly is provided. The hydraulic valve assembly can include a first cover that can define a first pump inlet configured to couple to a first pump and a second pump inlet configured to couple to a second pump. The hydraulic valve assembly can further include a first valve section assembly that can include a first valve section assembly and a second valve section assembly disposed between the first cover and including a second valve section. The first valve section can include a first housing in a first housing configuration that defines a first side, a second side, a first pump passage configured to couple to the first pump inlet and extending entirely through the first housing from the first side to the second side, a second pump passage configured to couple to the second pump inlet and extending entirely through the first housing from the first side, a first work port, and a first tank port. The first valve section can further include a first spool that can move within the first housing to selectively couple the first work port to the first tank port and at least one of the first pump passage and the second pump passage. The second valve section can include a second housing in a second housing configuration that defines a third side, a fourth side, a third pump passage configured to couple to the first pump inlet and extending entirely through the second housing from the third side to the fourth side, a second pump passage configured to couple to the second pump inlet and extending partially through the second housing from the first side, a second work port, and a second tank port. The second valve section can further include a second spool that can move within the second housing to selectively couple the second work port to the second tank port and at least one of the third pump passage and the fourth pump passage. The second side of the first valve section can be directly coupled to the third side of the second valve section so that the first pump passage can be in fluid communication with the third pump passage and the second pump passage can be blocked from the fourth pump passage.

According to still another aspect of the disclosure, a method of assembling a modular hydraulic valve assembly is provided. According to the method the method a valve stack can be formed by coupling a first valve section assembly to a second valve section assembly. The first valve section assembly can include a first housing in a first housing configuration that defines a first pump passage extending entirely through the first housing and a second pump passage extending partially through the first housing. The second valve section assembly can include a second housing in a second housing configuration that defines a third pump passage and a fourth pump passage that each extend entirely through the second housing. The valve stack can be secured between a first cover and a second cover. The first cover can define a first pump inlet that can be fluidly coupled to the first pump passage via the third pump passage, and a second pump inlet that can be fluidly coupled to the fourth pump passage.

In some non-limiting examples, a spool can be inserted into each of the first housing and the second housing. The spool (i.e., a spool of the first housing and a spool of the second housing) can be in one a first spool configuration configured to allow flow between the pump passages of the respective housing, and a second spool configuration configured to block flow between pump passages of the respective housing. In some cases, each spool in the first valve section assembly can be in the first spool configuration, and each spool in the second valve section assembly can be in the second spool configuration.

In some non-limiting examples, the valve stack can be formed by coupling a third valve section assembly to the first valve section assembly so that the first valve section assembly can be between the second valve section assembly and the third valve section assembly. The third valve section assembly can include a third housing in the first housing configuration that can be directly coupled to the first valve section assembly and a fourth housing in the second housing configuration that can be directly coupled to the second cover. The second cover can define a third pump inlet and a fourth pump inlet. The fourth pump inlet can be coupled to the first pump passage of the first housing via the first pump passage of the third housing and the third pump passage of the fourth housing.

### BRIEF DESCRIPTION OF DRAWINGS

The present disclosure will be better understood and features, aspects, and advantages other than those set forth above will become apparent when consideration is given to the following detailed description thereof. Such detailed description makes reference to the following drawings.

FIG. 1 is a perspective view of a non-limiting example of a hydraulic control system, according to aspects of the disclosure.

FIG. 2A is a partial exploded front perspective view of a non-limiting example of the hydraulic control system of FIG. 1.

FIG. 2B is a partial exploded rear perspective view of the non-limiting example of a hydraulic control system of FIG. 1.

FIG. 3 is a top view of a non-limiting example of the hydraulic control system of FIG. 1.

FIG. 4A is a front view of a non-limiting example of a housing in a first configuration, according to aspects of the disclosure.

FIG. 4B is a rear view of the housing of FIG. 4A.

FIG. 5A is a front view of a non-limiting example of a housing in a second configuration, according to aspects of the disclosure.

FIG. 5B is a rear view of the housing of FIG. 5A.

FIG. 6A is a schematic view of a non-limiting example of a valve section including a flow control element in a first configuration, according to aspects of the disclosure.

FIG. 6B is a schematic view of a non-limiting example of a valve section including a flow control element in a second configuration, according to aspects of the disclosure.

FIG. 6C is a cross-sectional view of a non-limiting example of a valve section based on the schematic of FIG. 6A.

FIG. 7A is a schematic view of a non-limiting example of a valve section including a flow control element according to a first configuration, according to aspects of the disclosure.

FIG. 7B is a schematic view of a non-limiting example of a valve section including a flow control element according to a second configuration, according to aspects of the disclosure.

FIG. 7C is a schematic view of a non-limiting example of a valve section including a flow control element according to a third configuration, according to aspects of the disclosure.

FIG. 8A is a cross-sectional view of a non-limiting example of a housing according to a first housing configuration based on the schematic of FIG. 7A.

FIG. 8B is a cross-sectional view of a non-limiting example of a housing according to a second housing configuration based on the schematic of FIG. 7B.

FIG. 9A is a perspective view of a non-limiting example of a flow control element according to a first configuration based on the schematic of FIG. 7A.

FIG. 9B is a perspective view of a non-limiting example of a flow control element according to a second configuration based on the schematic of FIG. 7B.

FIG. 10A is a cross-sectional view of a non-limiting example of a valve section based on the schematic of FIG. 7A, showing the flow control element in a neutral position.

FIG. 10B is a cross-sectional view of a non-limiting example of a valve section based on the schematic of FIG. 7A, showing the flow control element in a first operating position.

FIG. 10C is a cross-sectional view of a non-limiting example of a valve section based on the schematic of FIG. 7A, showing the flow control element in a second operating position.

FIG. 11 is a schematic view of a non-limiting example of a hydraulic control system, according to aspects of the disclosure.

FIG. 12 is a schematic view of a non-limiting example of a hydraulic control system, according to aspects of the disclosure.

FIG. 13 is a schematic view of a non-limiting example of a hydraulic control system, according to aspects of the disclosure.

FIG. 14 is a schematic view of a non-limiting example of a hydraulic control system, according to aspects of the disclosure.

FIG. 15 is a schematic view of a non-limiting example of a hydraulic control system, according to aspects of the disclosure.

FIG. 16 is a schematic view of a non-limiting example of a hydraulic control system, according to aspects of the disclosure.

### DETAILED DESCRIPTION

Before any aspects of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, as well as fluid couplings.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

Hydraulic control systems, in particular, hydraulic valves, can be used to selectively couple consumers (e.g., a hydraulic actuator or other hydraulic function) to one or more pumps that can supply hydraulic fluid at a desired pressure. With conventional designs, a hydraulic valve can include a plurality of valve sections that are arranged into a valve stack and configured to control a flow of fluid to a respective consumer. However, with such conventional designs, spacer plates a typically positioned between valve sections to isolate each valve section with a desired pump (i.e., to prevent undesired crossflow from multiple pumps into a single valve section). The use of spacer plates increases system complexity and also increases the overall size of the valve. Moreover, in many cases, conventional valve arrangements are typically customized in accordance with their desired use (e.g., as a valve block in a front end loader, excavator, or other off-highway machinery).

The present disclosure can provide advantages over conventional designs by providing for a modular valve that can eliminate the need for spacer plates between valve sections, thereby reducing the overall size of the valve. Additionally, the modular design of the valve allows a designer to select from two different housing configurations and three different spool configurations to allow a single valve stack to connect valve sections with, for example, three different pumps. More specifically, valve sections can be arranged into three different valve section assemblies, such that each valve section assembly can be coupled with a respective pump. In some cases, multiple valve stacks can be coupled together, with covers (i.e., pump inlets) between the valve stacks, to allow for additional pumps to be used. For example, a first valve stack and a second valve stack can be coupled in an opposed configuration about a first cover (i.e., a mid-inlet). In some non-limiting examples, the first valve stack can be coupled to three pumps and the second valve stack can be coupled to an additional three pumps, allowing the valve assembly to couple with a total of six pumps.

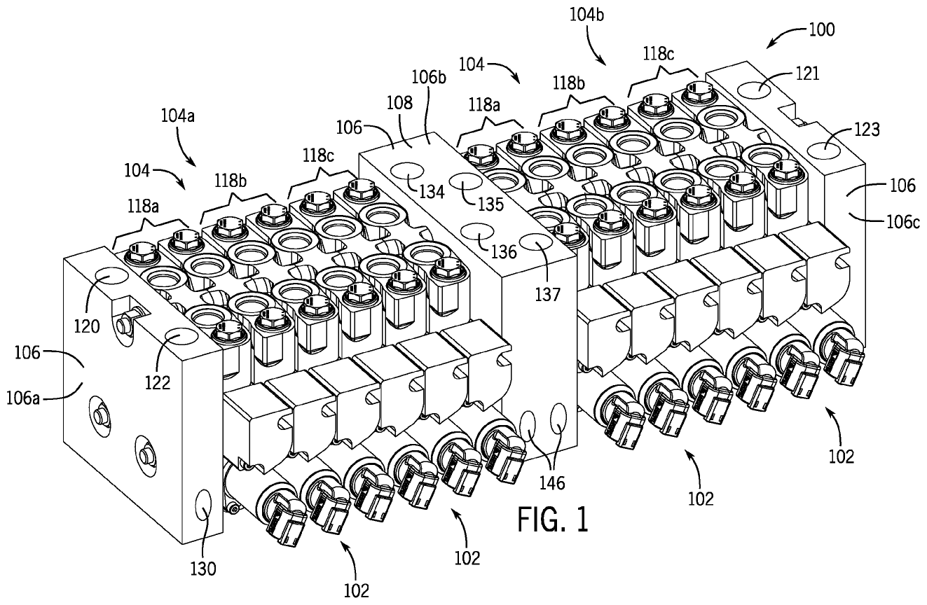

FIG. 1 illustrates a non-limiting example of a hydraulic control system 100 (i.e., a hydraulic valve), according to aspects of the disclosure. The hydraulic control system 100 generally includes a plurality of valve sections 102 that are arranged in an abutting, side-by-side configuration to define a valve stack 104 that extends between a pair of covers 106 (e.g., between a first cover and a second cover). As shown in FIG. 1, in some non-limiting examples, the hydraulic control system 100 can include more than one valve stack 104, with adjacent valve stacks 104 being coupled to one another along opposite ends of a cover 106, which can be configured as a mid-inlet cover 108. In other non-limiting examples, a hydraulic control system may include any number of additional valve stacks connected via any number of additional covers.

The covers 106 are configured to fluidly connect the valve sections 102 to multiple pump supplies. The multiple pump supplies are used to supply fluid to control operation of different actuatable elements that are coupled to the work ports 110, 112 of the valve sections 102. The covers 106 and optional mid-inlet covers 108 can also be configured to fluidly couple the valve sections 102 to a tank return. The valve sections 102 of each valve stack 104 define one or more valve sections 118a-c (collectively, valve section assemblies 118). Each of the valve section assemblies 118 can include one or more valve sections 102 that are configured to be operated using fluid received from the same pump supply.

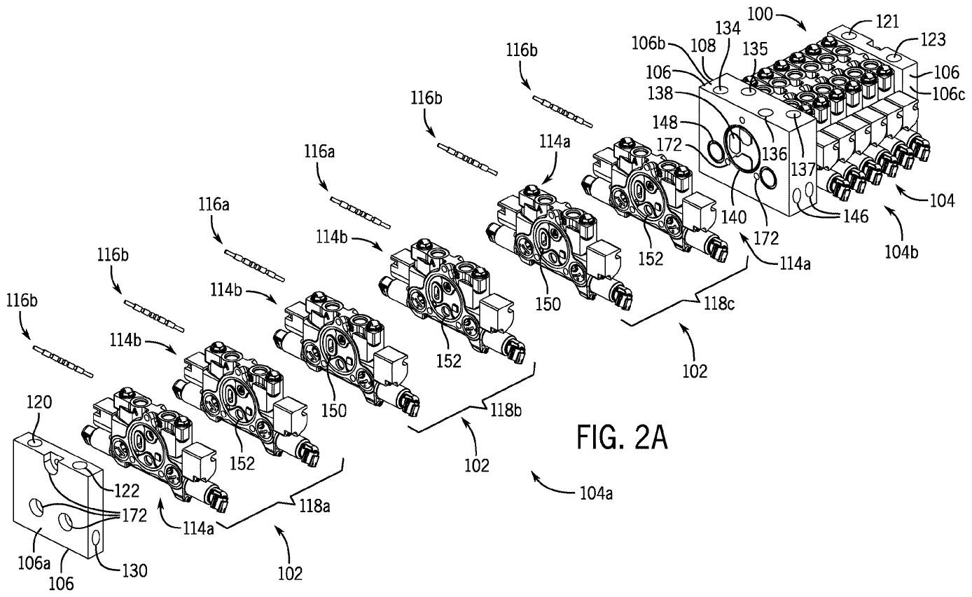

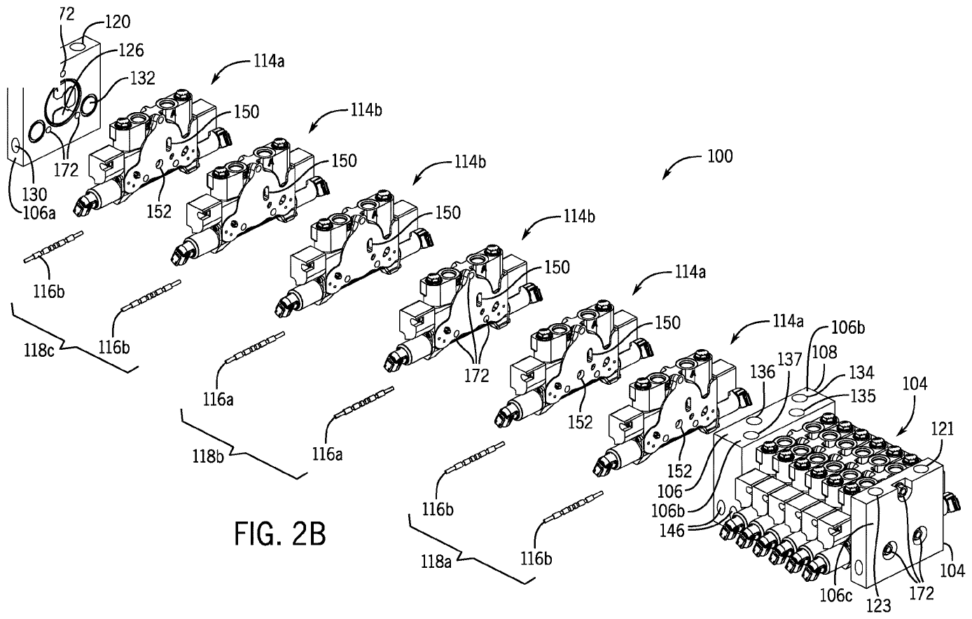

As illustrated in FIGS. 2A and 2B, each of the valve sections 102 of the hydraulic control system 100 generally includes a housing 114 and a flow control element 116 (e.g., a spool). The valve sections 102 of the hydraulic control system 100 are defined by a modular design in which each of the housings 114 can have either a first configuration 114a or a second configuration 114b (i.e., first and second housing configurations), and each of the flow control elements 116 can have either a first configuration 116a or a second configuration 116b (i.e., first and second spool configurations). The modular design allows any of the housing configurations 114a, 114b to be used with any of the flow control element configurations 116a, 116b, allowing for the creation of valve assembly configurations having different flow patterns therethrough. The modular design also allows each of the valve assembly configurations to be arranged in a side-by-side configuration to define the valve stack 104 while preventing undesired crossflow between pumps through the valve. That is, the various housing and flow control element combinations can be selected so that each valve section assembly can permit flow through its respective valve sections (i.e., the work ports thereof) from a desired pump or plurality of pumps, while preventing flow through from an undesired pump or plurality of pumps.

As discussed in detail below, the configurations of the housings 114 and the flow control elements 116 are each defined by structural differences via which the different housing configurations 114a, 114b and flow control element configurations 116a, 116b are able to achieve different flow patterns through a valve section 102. However, given their modular designs, the overall shape and design of each of the housings 114 and each of the flow control elements 116 generally share a number of common elements and features. Accordingly, for purposes of the descriptions herein, elements and features that are common to each housing 114, flow control element 116 and/or valve section 102 configuration are denoted using the same reference numerals. Similarly, unless specified that a particular feature, structure and/or function is unique to a particular housing 114, flow control element 116 and/or valve section 102 configuration(s), a description of any housing 114, flow control element 116 and/or valve section 102 configuration is generally intended to refer to a description of a respective housing 114, flow control element 116 and/or valve section 102 according to any configuration.

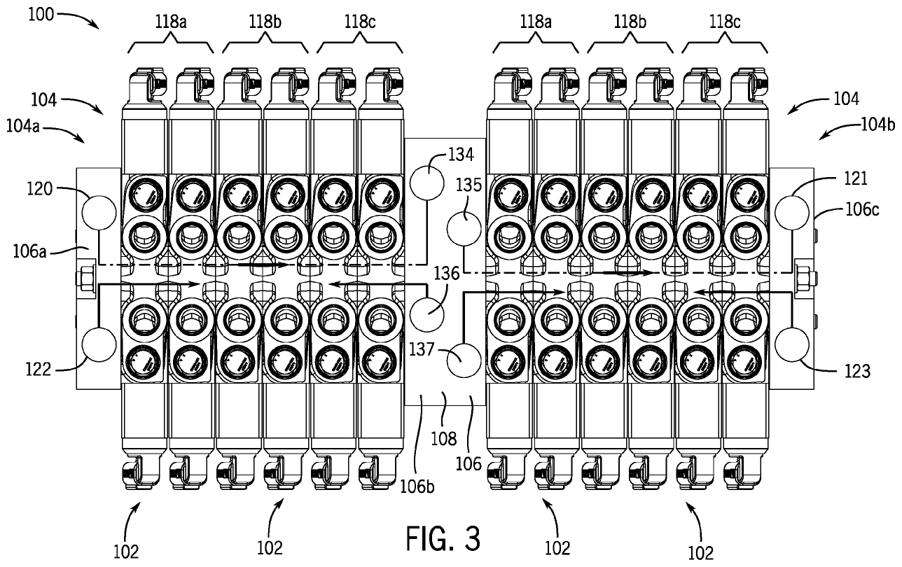

As discussed in additional detail below, the different valve section configurations advantageously allow the valve sections 102 to be uniquely arranged relative to one another to selectively define different valve section assemblies 118 along each valve stack 104. As illustrated by the flow lines in the non-limiting example of FIG. 3, each valve section assembly 118—which can each include one or more valve sections 102—is defined by a flow path that can be selectively fluidly isolated from the flow paths through the other valve sections 104. This selective isolation of the flow paths allows the different valve section assemblies 118 to be operated independently of one another using fluid supplied from a desired one or more different pump supplies. As also discussed in additional detail below, the modular design of the valve sections 102 allows each valve stack 104 of the hydraulic control system 100 to include three, and sometimes four, different valve section assemblies 118 that can be fluidly isolated from other valve section assemblies 118 of the valve stack 104.

Because the modular design allows different housing 114 and flow control element 116 configurations to be interchangeably coupled to create valve section 102 configurations defined by different flow patterns, the hydraulic control system 100 described herein is able to utilize the valve sections 102 themselves to isolate the different pump supplies used to control the different valve section assemblies 118 of a valve stack 104 from one another. Thus, the hydraulic control system 100 does not require the arrangement of any separate components (e.g., a spacer elements) along the valve stack 104 to provide fluid isolation between the work ports of the different valve section assemblies 118 in the valve stack 104. In addition to reducing the cost associated with the incorporation of additional components (i.e., spacer elements), the ability to avoid the need for any additional elements along the valve stack 104 to achieve the desired fluid isolation between valve section assemblies 118 advantageously helps reduce the length and weight of the valve stack 104.

Additionally, the discrete valve section assemblies 118 described herein can be achieved using as few as two different housing configurations 114a, 114b and two different flow control element configurations 116a, 116b. Correspondingly, the cost and effort associated with manufacturing and assembling the hydraulic control system 100 can be reduced. For example, because (as discussed below) the housing 114 of both the first configuration 114a and second configuration 114b is substantially similar in design but with an additional bore being formed entirely through the housing 114 of the first configuration 114a—the housings 114 for each of the valve sections 102 can generally be manufactured using a common machining or tooling process.

Referring to FIGS. 2A and 2B, additional details regarding the components of the hydraulic control system 100 are described according to non-limiting examples. As shown in FIGS. 2A and 2B, each of the covers 106 of the hydraulic control system 100 can include one or more pump ports, which can each be configured to couple to a pump that can supply hydraulic fluid to the hydraulic control system 100. For example, a first cover 106a can include a first pump port 120 and a second pump port 122 to which different pump supplies can be fluidly coupled. The first pump port 120 and second pump port 122 are each respectively fluidly coupled to a first pump supply opening 124 and a second pump supply opening 126 formed along a side surface 128 of the cover 106. In addition to the pump ports 120, 122, the covers 106 can include tank ports 130 and tank return openings 132. Correspondingly, a second cover 106b positioned on an opposite side of the valve stack 104 can also include first pump port 134 (i.e., a third pump port for the valve stack 104) and a second pump port 136 (e.g., a fourth pump port for the valve stack 104). In this way, the valve stack can be coupled with up to four different pumps. In some cases, a pump can be coupled to multiple ports, for example, the pump port 120 and the pump port 134.

In examples in which the hydraulic control system includes two or more valve stacks 104, the second cover 106b can be configured as the mid-inlet cover 108 to connect adjacent valve stacks 104. As mentioned above, the middle inlet cover 108 can include a first pump port 134 and second pump port 136 coupled to a first pump supply opening 138 and a second pump supply opening 140, respectively, along a first side surface 142. The first and second pump ports 134, 136 can be used to supply fluid to a first valve stack 104a from first and second pump supplies (e.g., third and fourth pump supplies for the first valve stack 104a). Additionally, the middle inlet cover can include a third pump port 135 and a fourth pump port 137 that can be used to supply fluid to the second valve stack 104b from a fifth pump supply and a sixth pump supply, respectively. The fluid can be provided through corresponding pump openings provided on a second side surface 144 of the mid-inlet cover 108 that is configured to engage with the second valve stack 140b. As shown in FIGS. 2A and 2B one or both of the side surfaces 142, 144 of the mid-inlet cover 108 can also include tank ports 146 and tank return openings 148 via which fluid from the first valve stack 104 and/or second valve stack 104 can be directed to a tank return.

Moreover, a third cover 106c can be coupled to an opposite side of the second valve stack 104b. The third cover 106c, can be configured similarly to the first cover 106a and can include a first pump port 121 and a second pump port 123 (e.g., third and fourth pump supplies for the second valve stack 104b), which can each couple to a corresponding pump supply (e.g., seventh pump supply and an eighth pump supply, respectively). Further, the third cover 104c can include tank ports and tank return openings.

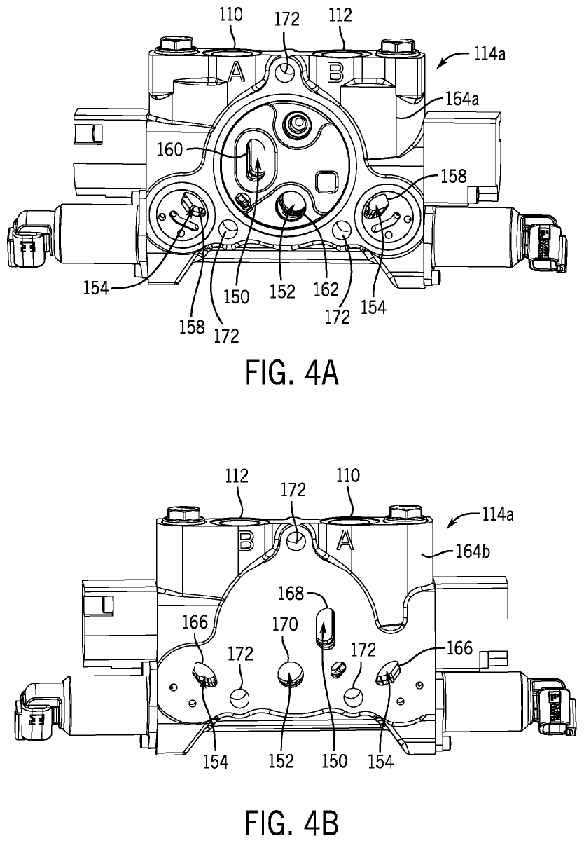

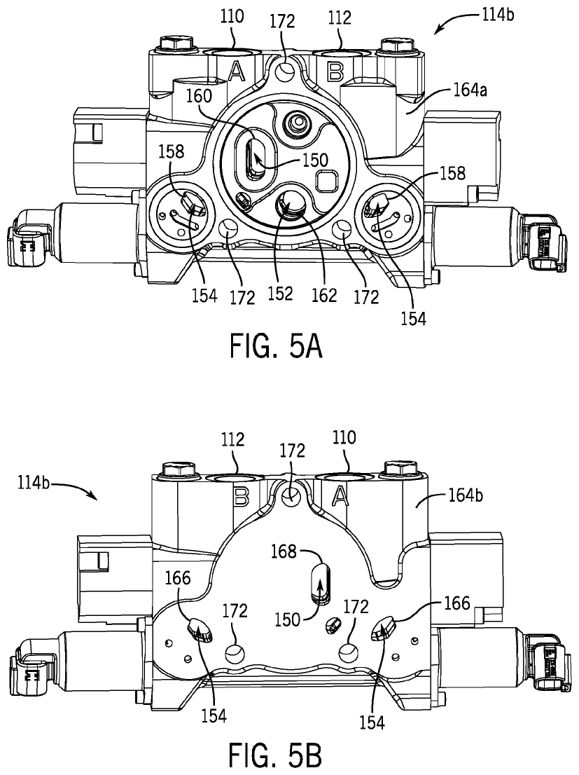

Referring to FIGS. 4A-5B, views of a housing 114 according to a first housing configuration 114a (i.e., FIGS. 4A and 4B) and according to a second housing configuration 114b (i.e., FIGS. 5A and 5B) are shown according to one non-limiting example. The housing 114 of each valve section 102 can include a first work port 110 and second work port 112 via which the valve section 102 can be operably coupled to an actuatable element. Each housing 114 also includes a first supply line 150 (i.e., a first pump passage), a second supply line 152 (e.g., a second pump passage) and a pair of tank return lines 154 (e.g., a tank port).

In each of the first housing configuration 114a and second housing configuration 114b, the tank return lines 154 and first supply line 150 extend entirely through the housing 144. In the first housing configuration 114a, the second supply line 152 also extends entirely through the housing 114. Accordingly, as shown in FIGS. 4A and 5A, the first side surface 164a of each of the first housing configuration 114a and second housing configuration 114b includes openings 158 for the tank return lines 154, an opening 160 for the first supply line 150 and an opening 162 for the second supply line 152. As shown in FIG. 4B, the second side surface 164b of the first housing configuration 114a also similarly includes openings 166 for the tank return lines 154, an opening 168 for the first supply line 150 and an opening 170 for the second supply line 152. However, in the second housing configuration 114b, the second supply line 152 does not extend entirely through the housing 114b, but instead terminates in a blind bore, such that fluid from the pump supply cannot pass through the housing 144 to a housing of an adjacent valve section. Accordingly, as shown in FIG. 5B, the second side surface 164b of the second housing configuration 114b includes only openings 166 for the tank return lines 154 and an opening 168 first supply line 150.

As illustrated in FIGS. 2A and 2B, during assembly of the hydraulic control system 100, the openings 158, 166 of the tank returns lines 154 are configured to be aligned with the tank return openings 132, 148 of the covers 106 and/or optional mid-inlet cover 108. Similarly, the openings 160, 168 of the first supply line 150 are configured to be aligned with the first pump supply openings 124, 138. Further, the openings 162, 170 of the second supply line 152 are configured to be aligned with the second pump supply openings 126, 140 of the covers 106 and/or optional mid-inlet cover 108. As discussed in detail below, the coupling of a valve stack 104 between first and second pump supply openings 124, 126 of a first cover 106 (to which a first and second pump supply may respectively be coupled) and first and second pump supply openings 124, 126 of a second cover 106, or optionally the first and second pump supply openings 138, 140 of a mid-inlet cover 108 (to which a third and fourth pump supply may respectively be coupled-in some cases the third and fourth pump supply can be the same pump supply), may provide the hydraulic control system 100 with the ability to supply the valve sections 102 of the valve stack 104 with fluid from up to four different pump supplies. In some cases, not all pump supply openings need to be used.

To ensure alignment between the pump supply openings 124, 126 of the covers 106 (or with the openings 138, 140 of an optional mid-inlet cover 108) and the openings of the housings 114 of the valve sections 102 during assembly of the hydraulic control system 100, the covers 106, including mid-inlet covers 108 and housings 114 can each include optional alignment openings 172 that are configured to receive tie elements (e.g., alignment pins, fasteners, tie rods, etc.) that can be used to both align and bind the end covers and valve assemblies to one another.

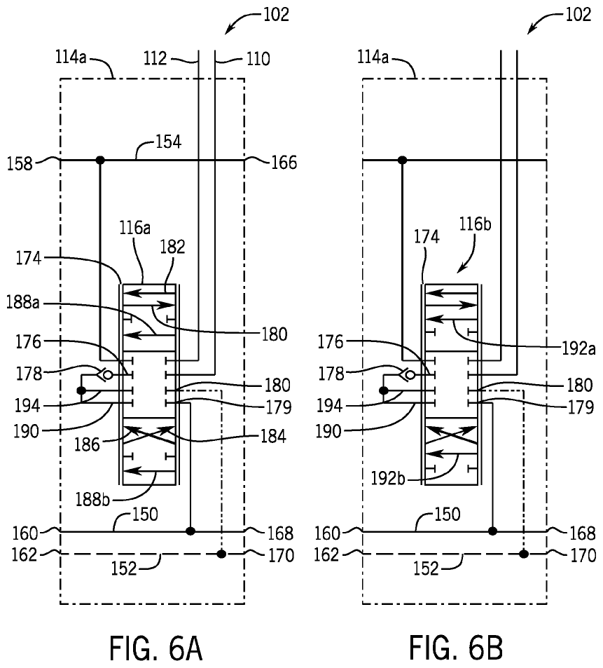

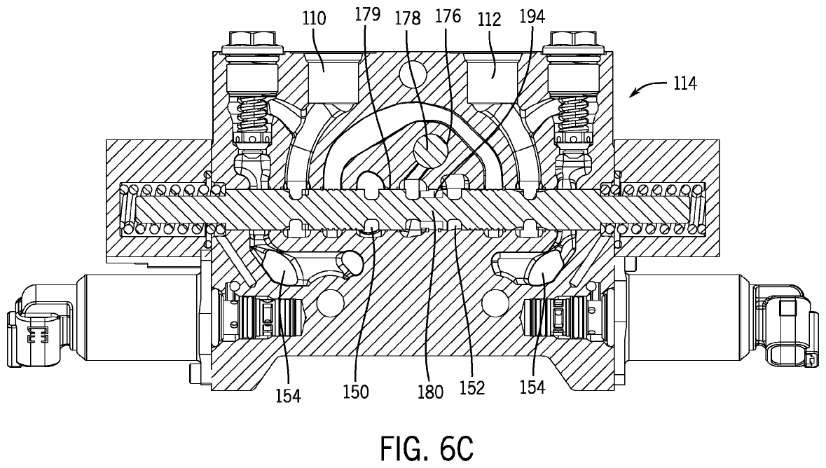

As illustrated in FIGS. 6A and 6B, the first and second work ports 110, 112, tank return lines 154, first supply line 150 and second supply line 152 of each housing 114 are each fluidly coupled to a central bore 174 of each housing 114. In some non-limiting examples, the first and second work ports 110, 112 and tank return lines 154 may be arranged relative to the central bore 174 in a bridge configuration. In such examples, fluid delivered to the central bore 174 from one, or both, of the first supply line 150 and second supply line 152 is selectively delivered to one of the first work port 110 and second work port 112 via a bridge inlet 176 depending on operation of the flow control element 116 (e.g., spool). A load check valve 178 may be provided between the bridge inlet 176 and the first and second supply lines 150, 152 to prevent back flow from the first and second work ports 110, 112 to the first and second supply lines 150, 152.

The flow control element 116 (e.g., a spool) of each valve section 102 is configured to be moveably received within the central bore 174 of each housing 114. As representatively explained with reference to the non-limiting valve section 102 examples of FIGS. 6A and 6B, when in a first neutral position, the flow control element 116 is configured to fluidly isolate both the first work port 110 and second work port 112 from each of the bridge inlet 176 (and correspondingly the first and/or second supply lines 150, 152 coupled thereto) and the tank return lines 154. When moved to a first operating position, the flow control element 116 is configured to fluidly couple the first work port 110 to the bridge inlet 176 via a first flow passageway 180, and couple the second work port 112 to the tank return lines 154 via a second flow passageway 182. When moved to a second operating position, the flow control element 116 is configured to fluidly couple the second work port 112 to the bridge inlet 176 via a third flow passageway 184, and couple the first work port 110 to the tank return lines 154 via a fourth flow passageway 186.

In addition to being configured to selectively control the fluid coupling of either the first work port 110 or second work port 112 to the bridge inlet 176, each flow control element 116 is also configured to selectively control the fluid connection of at least one of the first supply line 150 and second supply line 152 to the bridge inlet 176. As discussed below, flow control elements 116 according to different configurations (as well as flow control elements 116 according to different examples) are configured to achieve a different coupling of one, or both, of the first supply line 150 and second supply line 152 to the bridge inlet 176.

As illustrated by the non-limiting valve section 102 of FIGS. 6A and 6B, in some examples, an internal fluid circuit of the housing 114 is defined such that the fluid coupling of the first supply line 150 and second supply line 152 to the bridge inlet 176 is controlled entirely based on the flow control element 116. In such examples of a valve section 102, neither the first supply line 150 nor the second supply line 152 of the housing 114 are coupled directly to the bridge inlet 176. Instead, the first supply line 150 is connected to a first connection inlet 179 provided along the central bore 174 and the second supply line 152 is connected to a second connection inlet 179 provided along the central bore 174.

Shown in FIG. 6A is an example of a first flow control element configuration 116a that can be used with a housing 114 including an internal fluid circuit according to the example of FIGS. 6A and 6B. As shown in FIG. 6A, in addition to the passageways 180, 182, 184, 186 that are configured to selectively couple the first and second work ports 110, 112 to either the bridge inlet 176 or tank return lines 154 when the flow control element 116 is moved from the neutral position, flow control elements according to the first configuration of the flow control element 116a is such examples also includes a first connection passageways 188a, 188b defined in each of its first and second operating positions. When such a first configuration flow control element 116a is moved to either the first or second operating positions, the first connection passageways 188a, 188b are configured to couple the first connection inlet 179 to a corresponding first connection outlet 190 to which the bridge inlet 176 is fluidly coupled, thereby coupling the first supply line 150 to the selected first or second work port 110, 112.

Shown in FIG. 6B is an example of a flow control element 116 according to a second flow control element configuration 116b that can be used with a housing 114 including an internal fluid circuit according to the example of FIGS. 6A and 6B. As shown in FIG. 6B, the flow control element 116 according to the second configuration 116b similarly includes second connection passageways 192a, 192b that are configured to couple the second connection inlet 179 to a corresponding second connection outlet 195 to which the bridge inlet 176 is fluidly coupled, thereby coupling the second supply line 152 to the selected first or second work port 110, 112 when the flow control element 116 is moved to either its first or second operating positions.

Illustrated in FIG. 6C is a non-limiting example of housing 114 and flow control element structures that embody designs corresponding to the valve assembly circuits described with reference to FIGS. 6A and 6B.

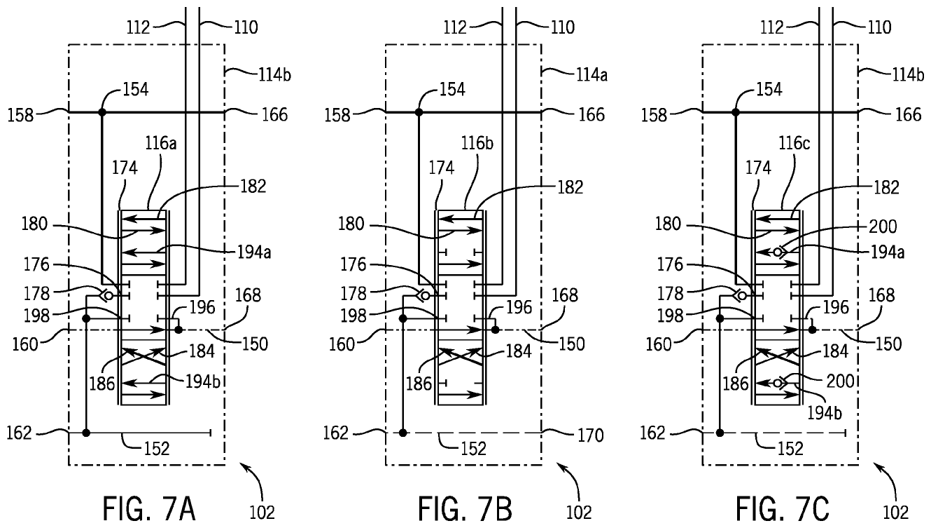

As an alternative to the internal fluid circuit that defines the housing 114 example described with reference to FIGS. 6A and 6B, in other valve assembly examples the housing 114 may be defined by an internal fluid circuit in which one of the fluid supply lines (e.g., the second supply line 152) bypasses the central bore 174 and instead may be coupled directly to the bridge inlet 176. For example, as shown in FIGS. 7A and 7B, the fluid connection between the second supply line 152 and the bridge inlet 176 is not dependent on the particular flow control element 116 configurations. In some such examples, the different configurations 116a, 116b of the flow control element 116 may accordingly instead be used to selectively either couple or isolate the other supply line (e.g., the first supply line 150) from the bridge inlet 176.

Shown in FIG. 7A is an example of a flow control element 116 according to a first flow control element configuration 116a that can be used with a housing 114 including an internal fluid circuit according to the example of FIGS. 7A and 7B. As shown in FIG. 7A, in addition to the passageways 180, 182, 184, 186 that are configured to selectively couple the first and second work ports 110, 112 to either the bridge inlet 176 or tank return lines 154 when the flow control element 116 is moved from the neutral position, the first configuration of the flow control element 116a in such examples also includes a first connection passageway 194a, 194b defined in each of its first and second operating position. When a flow control element according to the first configuration is moved to either the first or second operating positions, the first connection passageways 194a, 194b are configured to couple a first connection inlet 196 provided along the central bore 174 (and to which the first supply line 150 is directly fluidly connected) to a corresponding first connection outlet 198 to which the bridge inlet 176 is fluidly coupled, thereby couple the first supply line 150 to the selected first or second work port 110, 112.

Shown in FIG. 7B is an example of a flow control element 116 according to a second flow control element configuration 116b that can be used with a housing 114 including an internal fluid circuit according to the example of FIGS. 7A and 7B. In contrast to the first connection passageways 194a, 194b of the first flow control element configuration 116a, the second flow control element configuration 116b does not include any passageways that would connect the first connection inlet 196 to the first connection outlet 198 in either the first operating position or second operating position of the second flow control element configuration 116b. Accordingly-although valve sections 102 that include a second flow control element configuration 116b are able to transfer fluid in the first supply line through the housing (i.e., between the openings 160, 168 of the housing 114), valve sections 102 that include such a second flow control element configuration 116b are not able to supply fluid from the first supply line 150 to either the first work port or second work port 110, 112.

In valve sections 102 that incorporate a housing 114 includes an internal fluid circuit such as shown in FIGS. 7A and 7B, the first supply line 150 and second supply line 152 will be fluidly coupled whenever a valve section 102 having a flow control element 116 according to the first configuration 116a is moved to either the first or second operating positions as a result of the direct coupling of the second supply line 152 to the bridge inlet 176. Accordingly, supplying fluid to a valve section 102 via the first supply line 150 could result in the fluid flowing into the second supply line 152. Because the second supply line 152 in such valve section 102 examples is coupled directly to the bridge inlet 174, the flow of fluid delivered via the first supply line 150 to a first valve section 102 could unintentionally be delivered to valve sections 102 in other valve section assemblies 118. To prevent such scenarios, in some examples, the use of the first flow control configuration 116a may be restricted to use with housings 114 defined by a second housing configuration 114b that are arranged downstream from a valve section 102 that is similarly defined by a second housing configuration 114b.

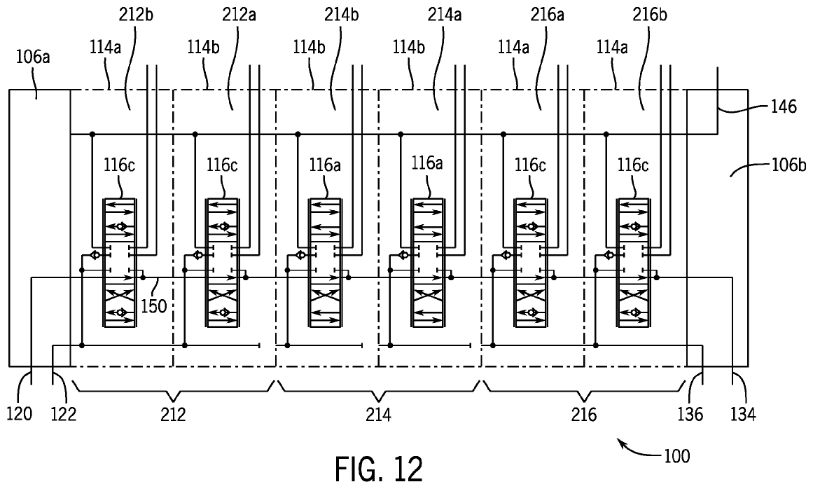

Another non-limiting example, fluid delivered from the second supply line 152 may be prevented from feeding into the first supply line 150 when using a valve section 102, while permitting unidirectional flow from the first supply line 150 to the second supply line 152, or vice versa. For example, with additional reference to FIG. 7C, the flow control element 116 can be in a third configuration 116c, which can be similar to that of the first configuration 116a, but with the addition of a check valve 200 along the first connection passageways 194a, 194b. As discussed in more detail below with reference to FIG. 12, in various non-limiting examples, the use of a flow control element 116c according to the third configuration may allow a valve section assembly 118 to be operated using a mix of fluid supplies coupled to each of the first supply line 150 and second supply line 152.

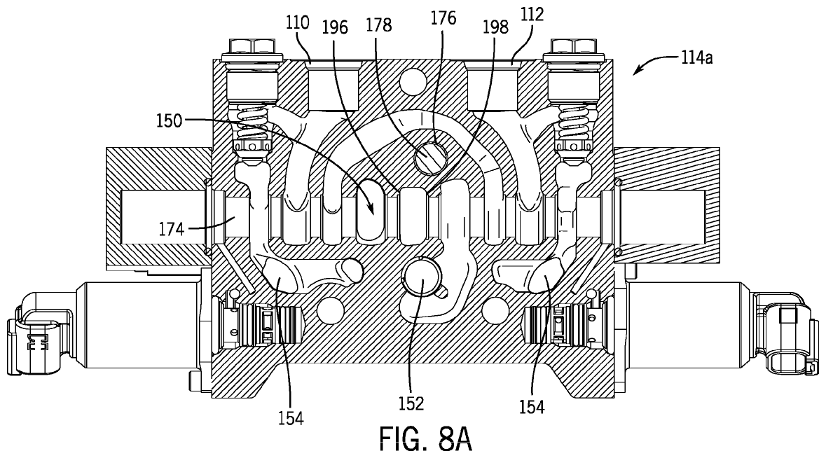

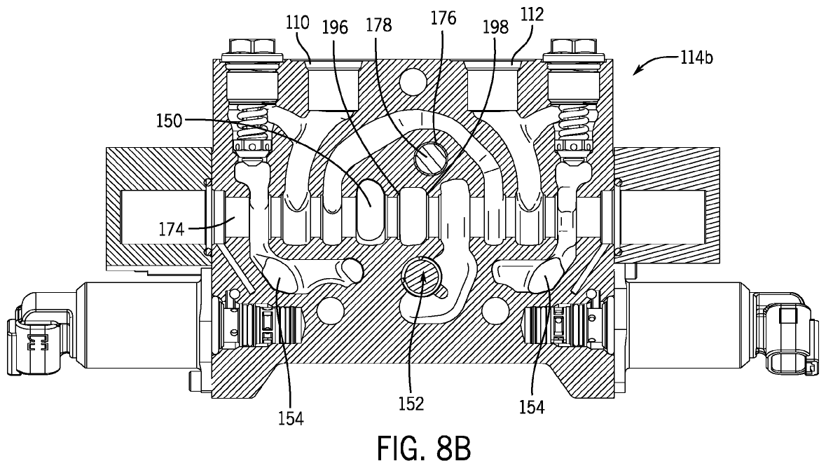

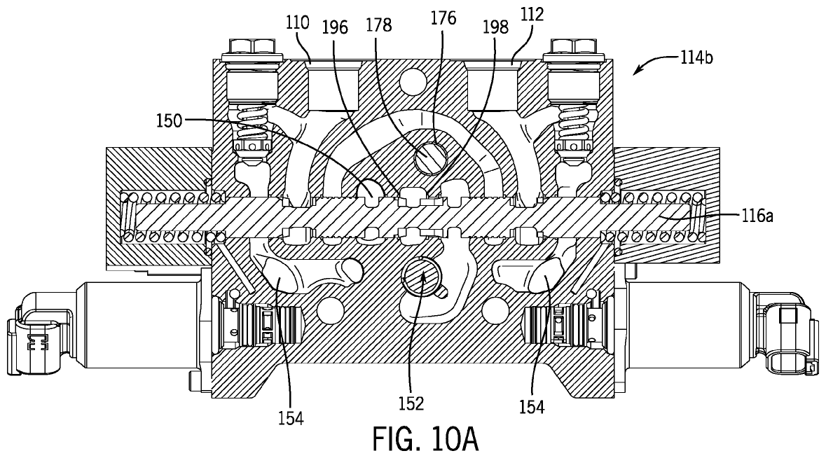

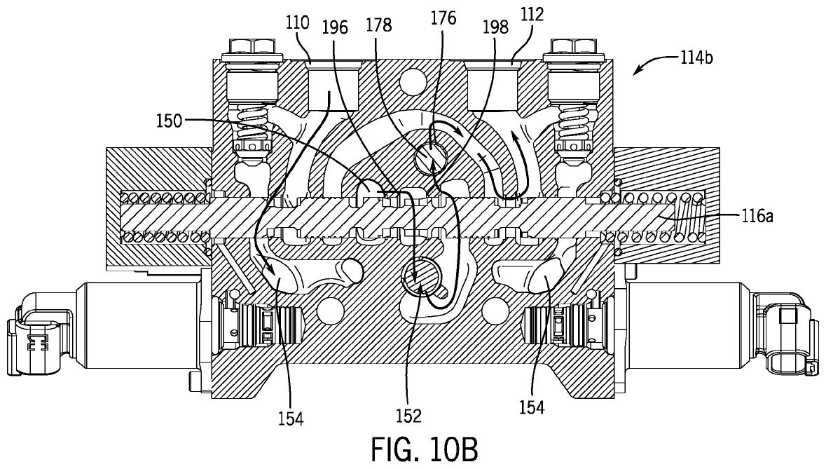

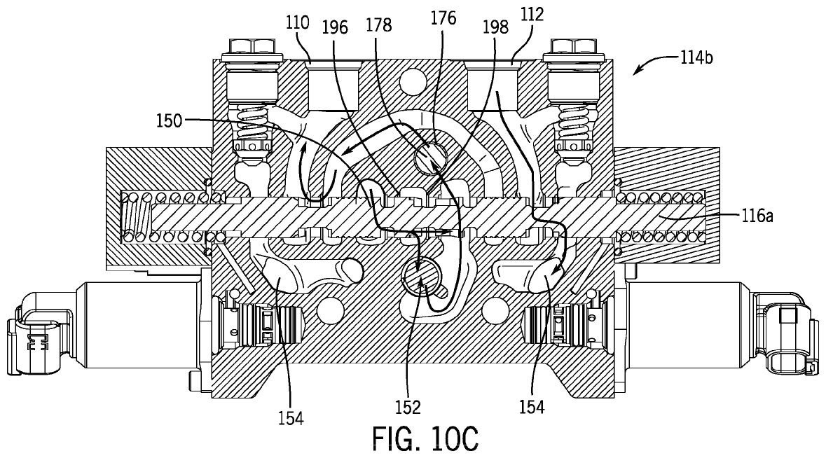

Illustrated in FIG. 8A is a non-limiting example of a housing structure according to a first housing configuration that embodies a design corresponding to the valve assembly circuit shown in FIG. 7B. Illustrated in FIG. 8B is a non-limiting example of a housing structure according to a second housing configuration that embodies a design corresponding to the valve assembly circuit shown in FIGS. 7A and 7C. Additional structural details of the valve section 102 shown in FIG. 7A are shown in FIGS. 10A-10C.

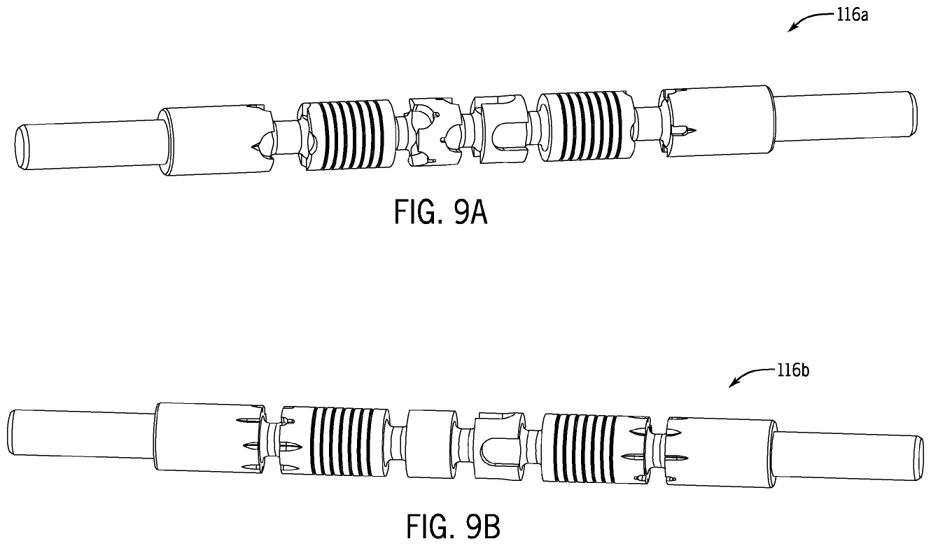

Illustrated in FIG. 9A is a non-limiting example of a flow control element structure that embodies a design corresponding to a first configuration of the flow control element 116a as described with reference to FIG. 7A. Illustrated in FIG. 9B is a non-limiting example of a flow control element structure that embodies a design corresponding to a second configuration of the flow control element 116b as described with reference to FIG. 7B.

As noted above, the modular design of the valve sections 102 allows for the creation of valve section 102 configurations that are defined by different flow patterns. Valve section 102 configurations having different flow patterns may then be selectively arranged to define a valve stack 104 defined by different valve section assemblies 118 having fluid supplies that are isolated from those of the other valve section assemblies 118. The valve sections 102 allow for three, and in some examples up to four, pump supplies to be fed to different valve section assemblies 118 of a valve stack 104. In examples in which a mid-inlet cover 108 is used to couple two valve stacks 104, the hydraulic control system 100 may be used to provide fluid to the actuatable elements of the valve sections 102 of the two valve stacks 104 from six, and in some examples eight, different pump supplies.

As described above, the modular design of the valve sections 102 includes housing 114 and flow control elements 116 defined by different configurations. The housings 114 may include a first, second, and in some examples, optionally a third configuration. Similarly, the flow control elements 116 may include first, second and optionally, a third configuration. The different flow patterns defined by the different valve section 102 configurations created using the housings 114 and flow control elements 116 are advantageously utilized to define valve section assemblies 118 that are fluidly isolated from one another.

For example, the blind bores of the second supply line 152 of the housings 114b according to the second configuration and those of the first supply line 150 of the third housing configuration 114c can be used to structurally isolate a valve section 102 defined by such a configuration from an adjacent valve section 102. As another example, the ability to selectively control the coupling of the first supply line 150 or second supply line 152 to the bridge inlet 176 provided by the different flow control element configurations 116a, 116b in valve section 102 examples (such as, e.g., those described above with reference to FIG. 6A and B) can similarly be used to functionally isolate a first valve section 102 including a flow control element 116 that selectively only couples the first supply line 150 to the first and second work port 110, 112 from a valve section 102 including a flow control element 116 that selectively couples the second supply line 152 to the first and second work port 110, 112.

As will be appreciated, in each of the various examples of hydraulic control systems 100 described herein, each valve section assembly 118 may be defined by any number of one or more valve sections 102 that are each configured to be operated using fluid supplied from the same pump supply. For example, when assembling a valve stack 104, once the endmost valve sections 102 of a valve section assembly 118 have been isolated from a neighboring valve section(s) 118 using an appropriate selection of a valve section 102 configuration configured to provide such desired isolation, any number of additional valve sections 102 that are configured to be operated using the same fluid supply may be interposed between the endmost valve sections 102 of the valve section assembly 118. In the illustrated non-limiting example, and with respect to a single valve stack 104, the endmost valve section 102 for each of valve section assemblies 118a and 118c is the valve section that is furthest from the first end cover 106 and the mid-inlet cover 108, respectively. As for the middle valve section assembly 118b, the endmost valve section(s) are those that directly couple to a valve section of the other valve section assemblies 118a, 118c. Put another way, the endmost valve sections 102 in a single valve stack 104 are those that define the boundary between adjacent valve section assemblies 118.

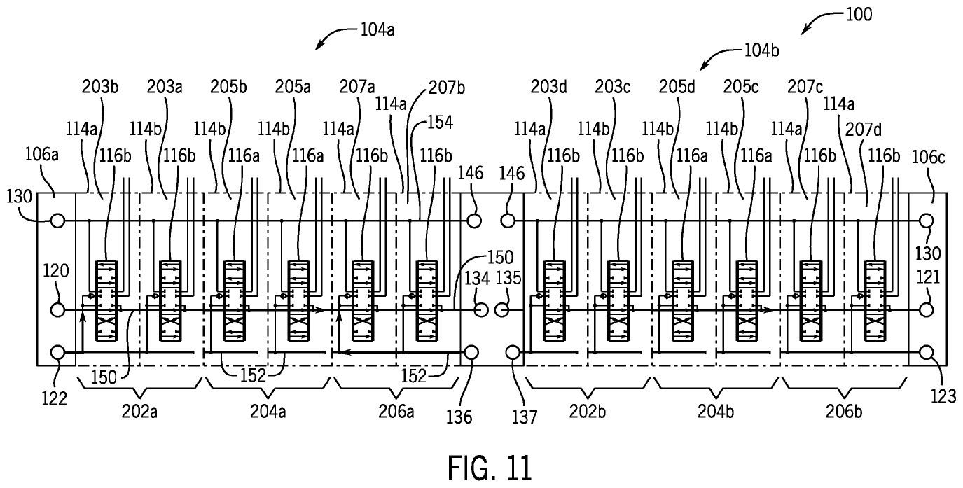

Illustrated in FIGS. 11-14 are various non-limiting examples of different hydraulic control systems 100 that can be defined using various combinations of the modular valve sections 102 described herein. For example, shown in FIG. 11 is a hydraulic control system 100 according to one non-limiting example which incorporates valve sections 102 including housings 114 with internal fluid circuits and flow control elements 116 with flow control element configurations as shown in FIGS. 7A and 7B.

As shown in FIG. 11, the hydraulic control system 100 includes multiple valve stacks. The first valve stack 104a is arranged between a first cover 106a and a second cover 106b, and includes a first valve section assembly 202a with valve sections 203a, 203b, a second valve section assembly 204a with valve sections 205a, 205b, and a third valve section assembly 206a with valve sections 207a, 207b. The second valve stack 104b is arranged between the second cover 106b and a third cover 106c and includes a third valve section assembly 202b with 203c, 203d, a fourth valve section assembly 204b that includes valve sections 205c, 205d, and a sixth valve section assembly 206b that includes valve sections 207c, 207d.

To provide isolation between the valve section assemblies 202a, 204a, 106a, a valve section 203a of the first valve section assembly 202a and a second valve section 205a of the second valve section assembly 204a include housings 114 with the second housing configuration 114b. Similarly, to provide isolation between the valve section assemblies 202b, 204b, 206b, a first valve section 203c of the first valve section assembly 202b and a second valve section 205c of the second valve section assembly 204b include housings 114 with the second housing configuration 114b.

As indicated by the arrows, and with respect to the first valve stack 104a, the blind bore of the second supply line 152 of the valve section 203a of the first valve section assembly 202a isolates fluid, which is received by the first valve section assembly 202a from a pump supply received via the second supply line 152 at pump port 122, from the second valve section assembly 204a. Similarly, for the second valve stack 104b, the blind bore of the second supply line 152 of the valve section 203c of the valve section assembly 202b isolates fluid, which is received by the first valve section assembly 202b from a pump supply received via the second supply line 152 at pump port 137, from the second supply line 152 second valve section assembly 204b.

Furthermore, for the first valve stack 104a, the blind bore of the second supply line 152 of the valve section 205a of the second valve section assembly 204a isolates fluid, which is received by the third valve section 206a from a pump supply received via the second supply line 152 at pump port 136, from the second supply line 152 of the second valve section 204a. Similarly, for the second valve stack 104b, the blind bore of the second supply line 152 of the valve section 205c of the second valve section assembly 204b isolates fluid, which is received by the third valve section 206b from a pump supply received via the second supply line 152 at pump port 123, from the second supply line 152 of the second valve section 204b.

Use of flow control elements 116 according to the second flow control element configuration 116b in each of the \valve section assemblies 202a, 202b and the valve section assemblies 206a, 206b allows fluid received by the valve section assemblies 204a, 204b via the first supply line 150 at pump port 120 (for the first valve stack 104a) and received at pump port 137 (for the second valve stack 104b) to be delivered to the valve section assembly 204a, 204b, while maintaining the fluid isolation between the various valve section assemblies 202a, 204a, 206a, 202b, 204b, 206b (i.e., at the work ports thereof).

As discussed above, each of the valve sections include both a first supply line 150 and second supply line 152 via which fluid from either a first pump supply or second pump supply may be supplied to the work ports 110, 112. Although in some examples in may be desired to limit each valve section 102 to using fluid from only a single pump supply, in some examples it may be desired to utilize fluid from each of the pump supplies to which the first supply line 150 and second supply line 152 are coupled.

Referring to FIG. 12, a hydraulic control system 100 configured to allow certain valve sections of a valve stack to draw fluid from each of the first supply line 150 and second supply line 152 is shown according to one non-limiting example. As shown in FIG. 12, the hydraulic control system 100 utilizes a valve stack having a first valve section assembly 212, second valve section assembly 214, and third valve section assembly 216 that are configured similar to the valve stack arrangements of FIG. 11 described above, but in which the flow control elements of the valve sections 102 of the first valve section assembly 212 and third valve section assembly 216 each include flow control elements 116 defined by a third flow control element configuration 116c such as described with reference to FIG. 7C above. The valve section assembly 212 include valve sections 213a, 213b, the second valve section assembly 214 includes valve sections 215a, 215b, and third valve section assembly 216 include valve sections 217a, 217b.

As discussed with reference to FIG. 7C, the first connection passageways 194a, 194b of the flow control elements 116c allow fluid from the first supply line 150 to be mixed with fluid delivered to the work ports 110, 112 from the second supply line 152 during operation of the valve sections 102 of each of the first valve section assembly 212 and third valve section assembly 216. The check valves 200 provided along the first connection passageways 194a, 194b can prevent backflow of fluid from the second supply line 152 into the flow of fluid through the first supply line 150. By ensuring that flow from the second supply line 152 into the first supply line 150 is prevented, the flow control elements 116c ensure isolation between the operations of each of the valve section 212, 214 and 216 of the hydraulic control system 100.

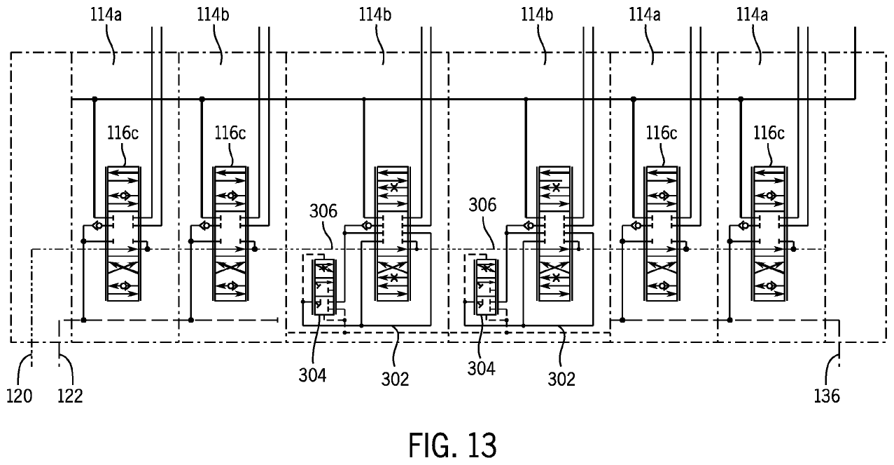

With reference to FIG. 13, in some non-limiting examples, a housing 114 of a valve section 302 may be defined by a valve section that includes a compensator assembly 304 arranged within a compensator bore. In such examples, the main supply line 306 of the valve section can define the first supply line 150. The compensator bore (with the compensator assembly removed therefrom) can define the second supply line 152 of a housing 114b according to the second configuration. Correspondingly, to form the second supply line 152 in the first housing configuration 114, the compensator bore can instead be formed or made into a through-hole that extends entirely through the housing.

In some examples, such a valve section with a compensator could be incorporated into the valve stack 104 of the hydraulic control system 100 in a manner that would allow the compensated valve section to be operated as normally intended alongside the operation of the valve sections 102 such as described herein.

For example, as shown and discussed with reference to the non-limiting hydraulic control system 100 of FIG. 13, the hydraulic control system 100 may utilize a second housing configuration 114b (i.e., a housing configuration that includes a second supply line 152 that terminates in a blind bore) to define a second valve section assembly 204 of a valve stack 104 so as to isolate the second valve section 204 from the first and third valve sections 202, 206. In such examples, the valve sections 102 of the second valve section assembly 204 can utilize a flow control element 116 that is configured to operate the valve section 102 using fluid supplied via the first supply line 150.

Because the valve sections 102 of the second valve section assembly 204 include housings 114 in the second housing configuration 114a, in which the second supply line 152 is formed as a blind bore extending partially through the housing, the second supply line 152 can repurposed for use as a compensator bore that can receive a compensator assembly 302. In this way, the second valve section assembly 204 can be provided with compensated valve sections without impacting the ability of the other valve sections of the first and third valve section assemblies 202, 206 to operate as intended.

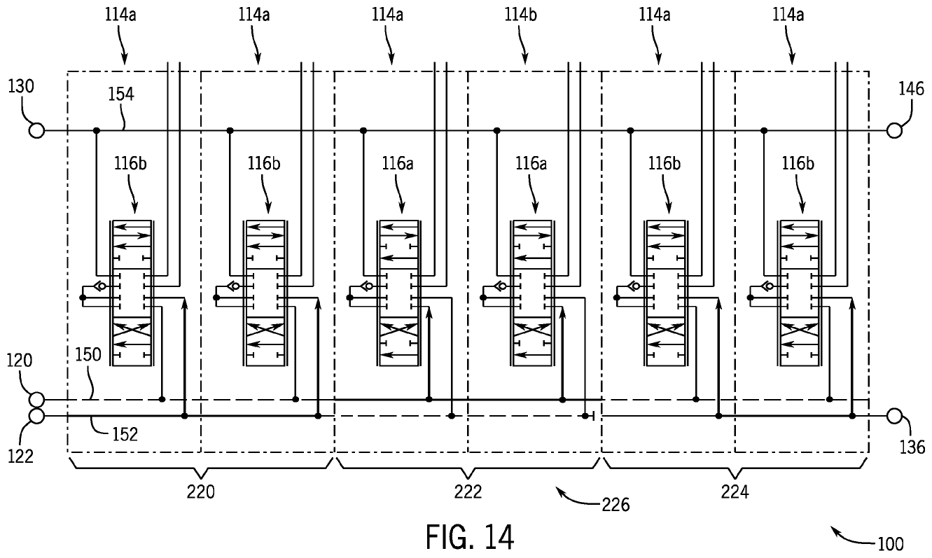

Referring now to FIG. 14, a hydraulic control system 100 according to one non-limiting example can include valve sections 102 having housings 114 with internal fluid circuits and flow control elements 116 with a flow control element configurations as shown in FIGS. 6A and 6B.

As shown in FIG. 14, the hydraulic control system 100 includes a first valve section assembly 220, second valve section assembly 222 and third valve section assembly 224. The valve sections 102 of each of the second valve section assembly 222 each include flow control elements in the first flow control element configuration 116a, while those of the first valve section assembly 220 and third valve section assembly 224 include flow control elements in the second flow control element configuration 116b. As discussed above with reference to FIGS. 6A and 6B, the first flow control element configuration 116a isolates the work ports 110, 112 of a valve section 102 from the second supply line 152, while the second flow control element configuration 116b isolates the work ports 110, 112 of a valve section 102 from the first supply line 150. Thus, fluid delivered to the work ports of the valve sections 102 of the second valve section assembly 222 from pump port 120a is isolated from the work ports of the valve sections 102 of the first valve section assembly 220, as well as those of the third valve section assembly 224. Similarly, fluid delivered to the work ports of the valve sections 102 of the first valve section assembly 220 from a second pump supply received via pump port 122a is isolated from the work ports of the valve sections 102 of the second valve section assembly 222.

To provide isolation between the fluid delivered to the second supply line 152 of the first valve section assembly 220 from that delivered to the second supply line 152 of the third valve section assembly 224, the end valve section 226 of the second valve section assembly 222 is defined by a second housing configuration 114b. Accordingly, as shown by the arrows, the valve sections of the first valve section assembly 220 can operate using fluid supplied from the second pump supply received via a second pump port 122a, while the valve assemblies of the third valve section assembly 224 can operate using fluid received from the second supply line 152 from a third pump supply coupled to the third pump port 122b. Fluid suppled at the first supply line 150 from the first pump port 120a can be delivered to all valve sections in the stack.

In some non-limiting examples, the use of an additional third housing configuration 114c may allow a hydraulic control system 100 to include up to four valve sections 118 that can each be independently controlled and operated using fluid from four different pump supplies. The overall housing 114 structure of the third housing configuration 114c is substantially similar to that of the second housing configuration 114b, in that the third housing configuration 114c includes a second supply line 152 that extends only partially through the housing 114.

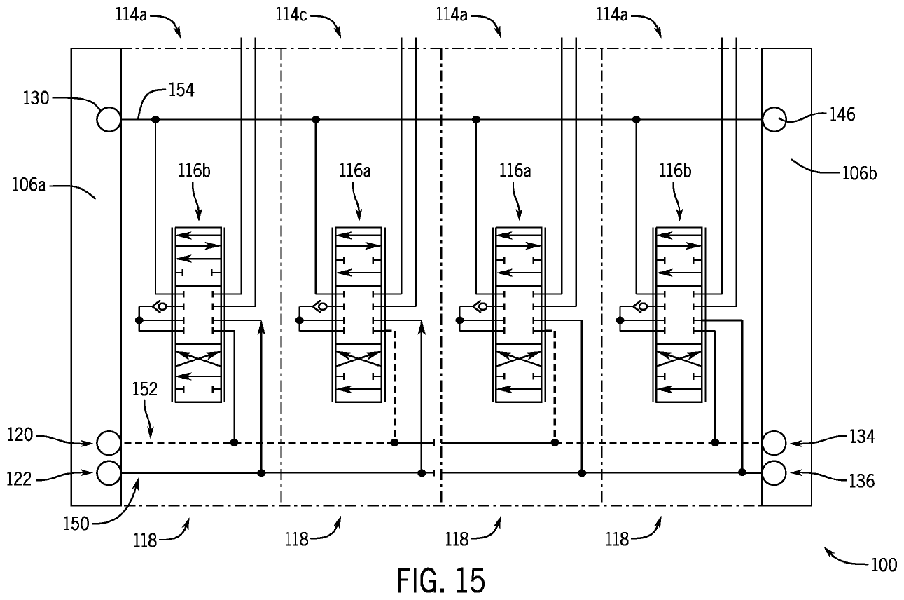

As shown in FIG. 15, in some non-limiting examples, a hydraulic control system 100 can include valve sections 102 having housings 114 and flow control elements 116, such as discussed above with reference to FIGS. 6A and 6B, that utilize a third housing configuration 114c to define a valve stack 104 having four valve sections 118, each of which can be independently supplied fluid from a different pump supply.

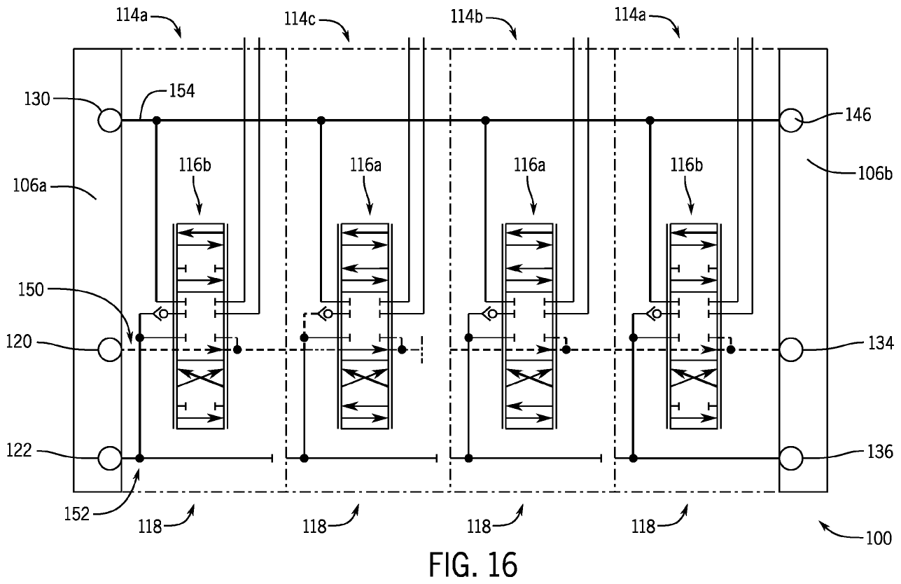

As shown in FIG. 16, in some non-limiting examples, a hydraulic control system 100 can include valve sections 102 having a housing 114 defined by an internal fluid circuit configuration and flow control elements 116, such as discussed above with reference to FIGS. 7A and 7B, that utilize a third housing configuration 114c to define a valve stack 104 having four valve sections 118 that are each independently supplied fluid from a different pump supply in shown in FIG. 16.

### FURTHER EXAMPLES

Example 1: A hydraulic valve (e.g., hydraulic control assembly 100) can include a first cover (e.g., cover 106b) defining a first pump inlet (e.g., pump supply opening 134) configured to couple to a first pump and a second pump inlet (e.g., pump supply opening 136) configured to couple to a second pump. The hydraulic valve can further include a first valve section assembly (e.g., valve section assembly 204a) and a second valve section assembly (e.g., valve section assembly 206a). The first valve section assembly can include a first valve section (e.g., valve section 205a). The first valve section can include a first housing in a first housing configuration (e.g., housing configuration 114b) that can define a first pump passage (e.g., supply opening 150), a second pump passage (e.g., supply opening 152), a first work port (e.g., work port 110), and a first tank port (e.g., tank return line 154). The first pump passage can be configured to couple to the first pump inlet and can extend entirely through the first housing. The second pump passage can be configured to couple to the second pump inlet and can extend partially through the first housing. The first valve section can further include a first spool (e.g., flow control element 116) that can move within the first housing to selectively couple the first work port to the first tank port and at least one of the first pump passage and the second pump passage. The second valve section assembly can be disposed between the first cover and the first valve section assembly and can include a second valve section (e.g., valve section 207a). The second valve section can include a second housing in a second housing configuration (e.g., housing configuration 114a) that can define a third pump passage (e.g., supply opening 150), a fourth pump passage (e.g., supply opening 152), a second work port (e.g., work port 110), and a second tank port (e.g., tank return line 154). The third pump passage can be configured to couple to the first pump inlet and can extend entirely through the second housing. The fourth pump passage can be configured to couple to the second pump inlet and can extend entirely through the second housing The second valve section can further include a second spool (e.g., flow control element 116) that can move within the second housing to selectively couple the second work port to the second tank port and at least one of the third pump passage and the fourth pump passage. The first valve section can be directly coupled to the second valve section so that the first pump passage can be in fluid communication with the third pump passage and the second pump passage can be blocked from the fourth pump passage.

Example 2: The hydraulic valve of Example 1, the first valve section assembly can include a third valve section (e.g., valve section 205b) coupled to the first valve section opposite the second valve section assembly. The third valve section can include a third housing in the first housing configuration. In some cases, the third valve section can be one of a plurality of third valve sections, which can be arranged in a stacked configuration within a valve stack.

Example 3: The hydraulic valve of Examples 1or 2, the second valve section assembly can include a fourth valve section (e.g., valve section 207b) coupled between the second valve section and the first cover. The fourth valve section can include a fourth housing in the second housing configuration. In some cases, the fourth valve section can be one of a plurality of fourth valve sections, which can be arranged in a stacked configuration within a valve stack.

Example 4: The hydraulic valve of Example 1 to 3 further comprising a second cover (e.g., cover 106a). The first valve section assembly can be coupled between the second cover and the second valve section assembly.

Example 5: The hydraulic valve of Example 4, wherein second cover can define at least one of a third pump inlet (e.g., pump supply opening 122) configured to couple to a third pump, and a fourth pump inlet (e.g., pump supply opening 120) configured to couple to a fourth pump.

Example 6: The hydraulic valve of Example 5, wherein the first pump and the fourth pump can be the same pump.

Example 7: The hydraulic valve of Examples 5 or 6 further comprising a third valve section assembly (e.g., valve section assembly 202a). The third valve section assembly can be disposed between the second cover and the first valve section assembly. The third valve section assembly can include a fifth valve section (e.g., valve section 203a) with a fifth housing in the first housing configuration. The first pump passage of the fifth valve section can be configured to couple to the fourth pump inlet and the second pump passage of the fifth valve section can be configured to couple to the third pump inlet.

Example 8: The hydraulic valve of Example 7, wherein the first pump passage of the fifth valve section can be in fluid communication with the first pump passage of the first valve section, and the second pump passage of the fifth valve section can be blocked from the second pump passage of the first valve section.

Example 9: The hydraulic valve of Examples 7 or 8, wherein the third valve section assembly can further include a sixth valve section (e.g., valve section 203b) with a sixth housing in the second housing configuration. The third pump passage of the sixth valve section can be in fluid communication with the first pump passage of the fifth valve section, and the fourth pump passage of the sixth valve section can be in fluid communication with the second pump passage of the fifth valve section. In some cases, the sixth valve section can be one of a plurality of sixth valve sections, which can be arranged in a stacked configuration within a valve stack.

Example 10: The first spool can be in one of a first spool configuration (e.g., spool configuration 116a) that allows fluid to flow between the first pump passage and the second pump passage, a second spool configuration (e.g., spool configuration 116b) that blocks fluid flow between the first pump passage and the second pump passage, and a third spool configuration (e.g., spool configuration 116c) that can include a check valve to allow unidirectional flow between the first pump passage to and the second pump passage.

Example 11: A hydraulic valve (e.g., hydraulic control assembly 100) can include a first cover (e.g., cover 106b) defining a first pump inlet (e.g., pump supply opening 134) and a second pump inlet (e.g., pump supply opening 136), a second cover (e.g., cover 106a) defining a third pump inlet (e.g., pump supply opening 122) and a fourth pump inlet (e.g., pump supply opening 120), and a first valve stack (e.g., valve stack 104a) arranged between the first cover and the second cover. The first valve stack can include a first valve section assembly (e.g., valve stack assembly 204a), a second valve section assembly (e.g., valve stack assembly 206a), and a third valve section assembly (e.g., valve stack assembly 202a). The first valve section assembly can include a first housing (e.g., of valve section 205a) in a first housing configuration (e.g., housing configuration 114b) that can define a first pump passage (e.g., supply opening 150) configured to couple to the first pump inlet and a second pump passage (e.g., supply opening 152) configured to couple to the second pump inlet. The first pump passage can extend entirely through the first housing and the second pump passage can extend partially through the first housing. The second valve section assembly can be disposed between the first cover and the first valve section assembly. The second valve section assembly can include a second housing (e.g., of valve section 207a) in a second housing configuration (e.g., housing configuration 114a) that can define a third pump passage (e.g., supply opening 150) configured to couple to the first pump inlet and a fourth pump passage (e.g., supply opening 152) configured to couple to the second pump inlet. The third pump passage and the fourth pump passage can extend entirely through the second housing. The third valve section assembly can be disposed between the second cover and the first valve section assembly. The third valve section assembly can include a third housing (e.g., of valve section 203a) in the first housing configuration. The first pump passage of the third housing can be configured to couple to the third pump inlet and the second pump passage of the third housing can be configured to couple the fourth pump inlet.

Example 12: The hydraulic valve of Example 11, wherein the first cover can further define a fifth pump inlet (e.g., pump supply opening 135) and a sixth pump inlet (e.g., pump supply opening 137). The hydraulic valve can further include a third cover (e.g., cover 106c) defining seventh pump inlet (e.g., pump supply opening 121) and an eighth pump inlet (e.g., pump supply opening 123), and a second valve stack (e.g., valve stack 104b) arranged between the first cover and the third cover. The second valve stack can include a fourth valve section assembly (e.g., valve section assembly 204b), a fifth valve section assembly (e.g., valve section assembly 202b), and a sixth valve section assembly (e.g., valve section assembly 206b). The fourth valve section assembly can include a fourth housing (e.g., of valve section 205d) in the first housing configuration. The first pump passage of the fourth housing can be configured to couple to the fifth pump inlet and the second pump passage of the fourth housing can be configured to couple the sixth pump inlet. The fifth valve section assembly can be disposed between the first cover and the fourth valve section assembly, and can include a fifth housing (e.g., of valve section 203c) in the first housing configuration. The first pump passage of the fifth housing can be configured to couple to the fifth pump inlet and the second pump passage of the fifth housing can be configured to couple the sixth pump inlet. The sixth valve section assembly can be disposed between the third cover and the fourth valve section assembly, and can include a sixth housing (e.g., of valve section 207c) in the second housing configuration. The third pump passage of the sixth housing can be configured to couple to the seventh pump inlet and the fourth pump passage of the sixth housing can be configured to couple to the eighth pump inlet.

Example 13: The hydraulic valve of Examples 11 or 12, wherein, for each of the first housing configuration and the second housing configuration, the respective housing can define a bore (e.g., central bore 174) configured to moveably receive a spool (e.g., flow control element 116) configured to selectively couple a work port (e.g., work port 110) to a tank port (e.g., tank return line 174) and a pump passage (e.g., supply opening 150, 152).

Example 14: The hydraulic valve of Example 13, wherein, for each of the first valve section assembly and the fourth valve section assembly, each spool can be in a first spool configuration (e.g., spool configuration 116a) that allows flow between the pump passages within the respective housing.

Example 15: The hydraulic valve of Examples 13 or 14, wherein, for each of the second valve section assembly, the third valve section assembly, the fifth valve section assembly, and the sixth valve section assembly, each spool can be in a second spool configuration (e.g., spool configuration 116b) that blocks flow between the pump passages of the respective housing.

Example 16: A hydraulic valve assembly (e.g., hydraulic control assembly 100) can include a first cover (e.g., cover 106b) that can define a first pump inlet (e.g., pump supply opening 134) configured to couple to a first pump and a second pump inlet (e.g., pump supply opening 136) configured to couple to a second pump. The hydraulic valve assembly can further include a first valve section assembly (e.g., valve section assembly 204a) that can include a first valve section (e.g., valve section 205a), and a second valve section assembly (e.g., valve section assembly 206a) disposed between the first cover and the first valve section assembly, and including a second valve section (e.g., valve section 207a). The first valve section can include a first housing in a first housing configuration (e.g., housing configuration 114b) that defines a first side (e.g., side 164a of the first housing configuration 114b), a second side (e.g., side 164b of the first housing configuration 114b), a first pump passage (e.g., supply opening 150) configured to couple to the first pump inlet and extending entirely through the first housing from the first side to the second side, a second pump passage (e.g., supply opening 152) configured to couple to the second pump inlet and extending partially through the first housing from the first side, a first work port (e.g., work port 110), and a first tank port (e.g., tank return line 154). The first valve section can further include a first spool (e.g., flow control element 116) that can move within the first housing to selectively couple the first work port to the first tank port and at least one of the first pump passage and the second pump passage. The second valve section can include a second housing in a second housing configuration (e.g., housing configuration 114a) that defines a third side (e.g., side 164a of the second housing configuration 114a), a fourth side (e.g., side 164b of the second housing configuration 114a), a third pump passage (e.g., supply opening 150) configured to couple to the first pump inlet and extending entirely through the second housing from the third side to the fourth side, a second pump passage (e.g., supply opening 152) configured to couple to the second pump inlet and extending entirely through the second housing from the first side, a second work port (e.g., work port 110), and a second tank port (e.g., tank return line 154). The second valve section can further include a second spool (e.g., flow control element 116) that can move within the second housing to selectively couple the second work port to the second tank port and at least one of the third pump passage and the fourth pump passage. The second side of the first valve section can be directly coupled to the third side of the second valve section so that the first pump passage can be in fluid communication with the third pump passage and the second pump passage can be blocked from the fourth pump passage.

Example 17: A method of assembling a modular hydraulic valve assembly (e.g., hydraulic control assembly 100) can include forming a valve stack (e.g., valve stack 104a) by coupling a first valve section assembly (e.g., valve section assembly 204a) to a second valve section assembly (e.g., valve section assembly 206a). The first valve section assembly can include a first housing in a first housing configuration (e.g., housing configuration 114b) that defines a first pump passage (e.g., supply opening 150) extending entirely through the first housing and a second pump passage (e.g., supply opening 152) extending partially through the first housing. The second valve section assembly can include a second housing in a second housing configuration (e.g., housing configuration 114a) that defines a third pump passage (e.g., supply opening 150) and a fourth pump passage (e.g., supply opening 152) that each extend entirely through the second housing. The method can further include securing the valve stack between a first cover (e.g., cover 106b) and a second cover (e.g., cover 106a). The first cover can define a first pump inlet (e.g., pump supply opening 134) that is fluidly coupled to the first pump passage via the third pump passage and a second pump inlet (e.g., pump supply opening 136) that is fluidly coupled to the fourth pump passage.

Example 18: The method of Example 17, wherein a spool (e.g., flow control element 116) can be inserted into each of the first housing and the second housing. The spool (i.e., a flow control element of the first housing and a spool of the second housing) can be in one a first spool configuration (e.g., spool configuration 116a) configured to allow flow between the pump passages of the respective housing, and a second spool configuration (e.g., spool configuration 116b) configured to block flow between pump passages of the respective housing.

Example 19: The method of Example 18, wherein each spool in the first valve section assembly is in the first spool configuration, and each spool in the second valve section assembly is in the second spool configuration.

Example 20: The method of any of Examples 17 to 19, wherein forming the valve stack can further include coupling a third valve section assembly (e.g., valve section assembly 202a) to the first valve section assembly so that the first valve section assembly is between the second valve section assembly and the third valve section assembly.

Example 21: The method of Example 20, wherein the third valve section assembly can include a third housing in the first housing configuration that can be directly coupled to the first valve section assembly, and a fourth housing in the second housing configuration that can be directly coupled to the second cover.

Example 22: The method of Example 21, wherein the second cover defines a third pump inlet (e.g., pump supply opening 122) and a fourth pump inlet (e.g., pump supply opening 120), the fourth pump inlet being coupled to the first pump passage of the first housing via the first pump passage of the third housing and the third pump passage of the fourth housing.

While the above examples have been described in connection with the non-limiting example hydraulic control assembly 100 shown in FIG. 11, it is appreciated that these examples are not to be limited to FIG. 11. Instead, it is appreciated that the principles described in connection with the above examples can be implemented in other ways.

Accordingly, within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, it will be appreciated by those skilled in the art that, while the disclosure has been described above in connection with particular non-limiting examples and examples, the disclosure is not necessarily so limited, and numerous other non-embodiments, examples, uses, modifications and departures from the non-limiting examples, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A hydraulic valve, comprising:
a first cover defining a first pump inlet configured to couple to a first pump and a second pump inlet configured to couple to a second pump;
a first valve section assembly including a first valve section that includes:
a first housing in a first housing configuration that defines a first pump passage configured to couple to the first pump inlet and extending entirely through the first housing, a second pump passage configured to couple to the second pump inlet and extending partially through the first housing, a first work port, and a first tank port; and
a first spool movable within the first housing to selectively couple the first work port to the first tank port and at least one of the first pump passage and the second pump passage; and
a second valve section assembly disposed between the first cover and the first valve section assembly, the second valve section assembly including a second valve section that includes:
a second housing in a second housing configuration that defines a third pump passage configured to couple to the first pump inlet and extending entirely through the second housing, a fourth pump passage configured to couple to the second pump inlet and extending entirely through the second housing, a second work port, and a second tank port; and
a second spool movable within the second housing to selectively couple the second work port to the second tank port and at least one of the third pump passage and the fourth pump passage,
wherein the first valve section is directly coupled to the second valve section so that the first pump passage is in fluid communication with the third pump passage and the second pump passage is blocked from the fourth pump passage.

2. The hydraulic valve of claim 1, wherein the first valve section assembly includes a third valve section coupled to the first valve section opposite the second valve section assembly, the third valve section having a third housing in the first housing configuration.

3. The hydraulic valve of claim 1, wherein the second valve section assembly includes a fourth valve section coupled between the second valve section and the first cover, the fourth valve section having a fourth housing in the second housing configuration.

4. The hydraulic valve of claim 1 further comprising a second cover, wherein the first valve section assembly is coupled between the second cover and the second valve section assembly.

5. The hydraulic valve of claim 4, wherein the second cover defines at least one of a third pump inlet configured to couple to a third pump and a fourth pump inlet configured to couple to a fourth pump.

6. The hydraulic valve of claim 5, wherein the first pump and the fourth pump are the same pump.

7. The hydraulic valve of claim 5 further comprising a third valve section assembly disposed between the second cover and the first valve section assembly, the third valve section assembly including a fifth valve section with a fifth housing in the first housing configuration,
wherein the first pump passage of the fifth valve section is configured to couple to the fourth pump inlet, and the second pump passage of the fifth valve section is configured to couple to the third pump inlet.

8. The hydraulic valve of claim 7, wherein the first pump passage of the fifth valve section is in fluid communication with the first pump passage of the first valve section, and the second pump passage of the fifth valve section is blocked from the second pump passage of the first valve section.

9. The hydraulic valve of claim 7, wherein the third valve section assembly further includes a sixth valve section with a sixth housing in the second housing configuration, the third pump passage of the sixth valve section being in fluid communication with the first pump passage of the fifth valve section, and the fourth pump passage of the sixth valve section being in fluid communication with the second pump passage of the fifth valve section.

10. The hydraulic valve of claim 1, wherein the first spool is in one of a first spool configuration that allows fluid to flow between the first pump passage and the second pump passage, a second spool configuration that blocks fluid flow between the first pump passage and the second pump passage, and a third spool configuration that includes a check valve to allow unidirectional flow between the first pump passage to and the second pump passage.

11. A hydraulic valve, comprising:
a first cover defining a first pump inlet and a second pump inlet;
a second cover defining a third pump inlet and a fourth pump inlet; and
a first valve stack arranged between the first cover and the second cover, the first valve stack including:
a first valve section assembly including a first housing in a first housing configuration that defines a first pump passage configured to couple to the first pump inlet and extending entirely through the first housing, a second pump passage configured to couple to the second pump inlet and extending partially through the first housing;
a second valve section assembly disposed between the first cover and the first valve section assembly, the second valve section assembly including a second housing in a second housing configuration that defines a third pump passage configured to couple to the first pump inlet and extending entirely through the second housing, and a fourth pump passage configured to couple to the second pump inlet and extending entirely through the second housing; and
a third valve section assembly disposed between the second cover and the first valve section assembly, the third valve section assembly including a third housing in the first housing configuration, the first pump passage of the third housing configured to couple to the fourth pump inlet and the second pump passage of the third housing configured to couple the third pump inlet.

12. The hydraulic valve of claim 11, wherein the first cover further defines a fifth pump inlet and a sixth pump inlet, and
wherein the hydraulic valve further comprises:
a third cover defining seventh pump inlet and an eighth pump inlet; and
a second valve stack arranged between the first cover and the third cover, the second valve stack including:
a fourth valve section assembly including a fourth housing in the first housing configuration, the first pump passage of the fourth housing configured to couple to the fifth pump inlet and the second pump passage of the fourth housing configured to couple the sixth pump inlet;
a fifth valve section assembly disposed between the first cover and the fourth valve section assembly, the fifth valve section assembly including a fifth housing in the first housing configuration, the first pump passage of the fifth housing configured to couple to the fifth pump inlet and the second pump passage of the fifth housing configured to couple the sixth pump inlet; and
a sixth valve section assembly disposed between the third cover and the fourth valve section assembly, the sixth valve section assembly including a sixth housing in the second housing configuration, the third pump passage of the sixth housing configured to couple to the seventh pump inlet and the fourth pump passage of the sixth housing configured to couple to the eighth pump inlet.

13. The hydraulic valve of claim 12, wherein, for each of the first housing configuration and the second housing configuration, the respective housing defines a bore configured to moveably receive a spool configured to selectively couple a work port to a tank port and a pump passage.

14. The hydraulic valve of claim 13, wherein, for each of the first valve section assembly and the fourth valve section assembly, each spool is in a first spool configuration that allows flow between the pump passages within the respective housing.

15. The hydraulic valve of claim 13, wherein, for each of the second valve section assembly, the third valve section assembly, the fifth valve section assembly, and the sixth valve section assembly, each spool is in a second spool configuration that blocks flow between the pump passages of the respective housing.

16. A hydraulic valve assembly, comprising:
a cover defining a first pump inlet configured to couple to a first pump and a second pump inlet configured to couple to a second pump;
a first valve section assembly including a first valve section that includes:
a first housing in a first housing configuration that defines a first side, a second side, a first pump passage configured to couple to the first pump inlet and extending entirely through the first housing from the first side to the second side, a second pump passage configured to couple to the second pump inlet and extending partially through the first housing from the first side, a first work port, and a first tank port; and
a first spool movable within the first housing to selectively couple the first work port to the first tank port and at least one of the first pump passage and the second pump passage; and
a second valve section assembly disposed between the first cover and the first valve section assembly, the second valve section assembly including a second valve section that includes:
a second housing in a second housing configuration that defines a third side, a fourth side, a third pump passage configured to couple to the first pump inlet and extending entirely through the second housing from the third side to the fourth side, a fourth pump passage configured to couple to the second pump inlet and extending entirely through the second housing from the first side, a second work port, and a second tank port; and
a second spool movable within the second housing to selectively couple the second work port to the second tank port and at least one of the third pump passage and the fourth pump passage,
wherein the second side of the first valve section is directly coupled to the third side of the second valve section so that the first pump passage is in fluid communication with the third pump passage and the second pump passage is blocked from the fourth pump passage.

17. A method of assembling a modular hydraulic valve assembly, the method comprising:
forming a valve stack by coupling a first valve section assembly to a second valve section assembly, the first valve section assembly including a first housing in a first housing configuration that defines a first pump passage extending entirely through the first housing and a second pump passage extending partially through the first housing, and the second valve section assembly including a second housing in a second housing configuration that defines a third pump passage and a fourth pump passage that each extend entirely through the second housing; and
securing the valve stack between a first cover and a second cover, the first cover defining a first pump inlet that is fluidly coupled to the first pump passage via the third pump passage and a second pump inlet that is fluidly coupled to the fourth pump passage.

18. The method of claim 17 further comprising inserting a spool into each of the first housing and the second housing, the spool being in a first spool configuration configured to allow flow between the pump passages of the respective housing, and a second spool configuration configured to block flow between the pump passages of the respective housing.

19. The method of claim 18, wherein each spool in the first valve section assembly is in the first spool configuration, and
wherein each spool in the second valve section assembly is in the second spool configuration.

20. The method of claim 17, wherein forming the valve stack further includes coupling a third valve section assembly to the first valve section assembly so that the first valve section assembly is between the second valve section assembly and the third valve section assembly.

21. The method of claim 20, wherein the third valve section assembly includes a third housing in the first housing configuration that is directly coupled to the first valve section assembly and a fourth housing in the second housing configuration that is directly coupled to the second cover.

22. The method of claim 21, wherein the second cover defines a third pump inlet and a fourth pump inlet, the fourth pump inlet being coupled to the first pump passage of the first housing via the first pump passage of the third housing and the third pump passage of the fourth housing.
